(19) United States
(12) Patent Application Publication
(10) Pub. No.: US 2009/0056740 A1
(43) Pub. Date: Mar. 5, 2009

(54) METHOD FOR CLEANING ALUMINUM ARTICLES

(75) Inventors: HONG-HAI XU, Shenzhen (CN); JIANG-RONG DING, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: SHENZHEN FUTAIHONG PRECISION INDUSTRY CO., LTD., ShenZhen City (CN); SUTECH TRADING LIMITED, Tortola (VG)

(21) Appl. No.: 11/964,803

(22) Filed: Dec. 27, 2007

(30) Foreign Application Priority Data
Aug. 31, 2007 (CN) 200710076772.3

(51) Int. Cl. B08B 3/04; B08B 3/12

(52) U.S. Cl. 134/1; 134/29

(57) ABSTRACT

A method for cleaning aluminum article includes steps of first water washing for a aluminum article; cleaning the aluminum article with mildly alkaline solution which including phosphate, carbonate and silicate; and second water washing for the aluminum article.

### BACKGROUND OF THE INVENTION

1. Field of the Invention

The present invention relates to methods for cleaning articles, particularly, to a method for cleaning aluminum articles.

2. Description of Related Art

Aluminum products, such as shells and parts of portable electronic devices, are widely used in our daily life. In manufacturing processes of the aluminum products, oil stains often exist on the surface of an aluminum article, in semi-manufactured state. In addition, since the aluminum article is generally exposed in the air, the surface of the aluminum article along with the aluminum articles are easily oxidized. Such oxidization and oil stains affect the next step of the manufacturing processes of the aluminum article, such as painting. Therefore, it is necessary to clean the oil stains and the oxides on the aluminum article.

A typical method for cleaning aluminum articles includes the steps of washing and drying. Cleaning solution such as methyl caprate solution is generally used to clean oil stains on the surfaces of the aluminum articles. The cleaning solution generally includes many kinds of surface active agents so as to remove oxide on the surfaces of the aluminum articles. However, the cleaning solution including surface active agents are generally strong alkali solution, such as potassium hydroxide solution, which may erode the aluminum articles and damage the surfaces of the aluminum articles. This will reduce the quality of the aluminum articles.

Therefore, a new method for cleaning aluminum articles is desired in order to overcome the above-described problems.

### SUMMARY OF THE INVENTION

In one embodiment thereof, a method for cleaning aluminum articles includes steps of first water washing treatment for a aluminum article; cleaning the aluminum article with mildly alkaline solution which contains phosphate, carbonate and silicate; and second water washing treament for the aluminum article.

Other advantages and novel features will become more apparent from the following detailed description when taken in conjunction with the accompanying drawing.

### BRIEF DESCRIPTION OF THE DRAWING

Many aspects of the method for cleaning aluminum articles can be better understood with reference to the following drawing. The components in the drawing are not necessarily drawn to scale, the emphasis instead being placed upon clearly illustrating the principles of the present cleaning method, wherein:

FIG. 1 is a flow chart of a method for cleaning aluminum articles according to an embodiment of the present invention; and

FIG. 2 is an isometric view of a holder used in the method shown in FIG. 1.

### DETAILED DESCRIPTION OF THE INVENTION

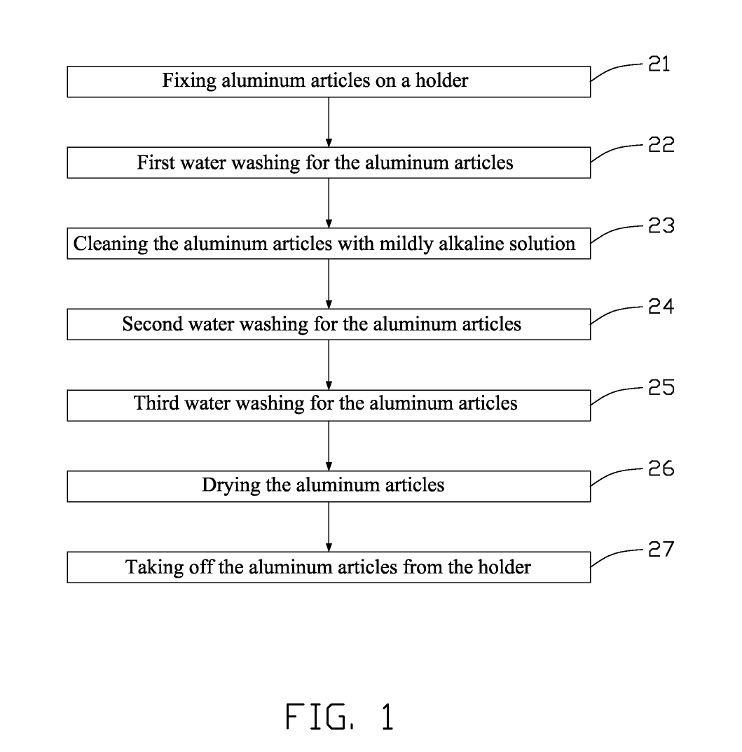

Aluminum products, such as shells and parts of portable electronic devices, generally require a surface treatment so as to improve the appearance or quality thereof. Since the surfaces of the aluminum articles need to be kept clean before surface treatment, impurities (eg., dust, oil strains or oxides) need to be removed from the aluminum articles. In addition, the surfaces of the aluminum articles should avoid eroding from strong alkali solution during removing the impurities thereon. Referring to FIG. 1, a method for cleaning aluminum articles, in accordance with an embodiment of the present invention includes the following steps:

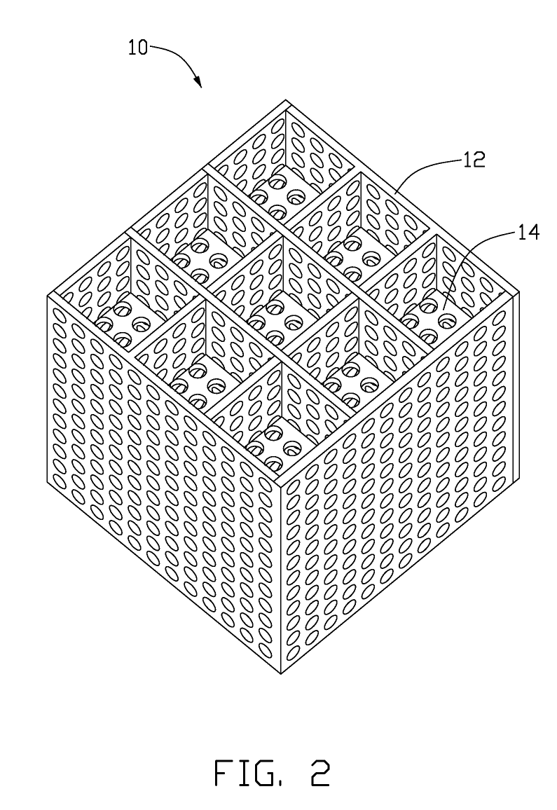

step 21, fixing aluminum articles on a holder 10 (referring to FIG. 2);

step 22, first water washing treatment for the aluminum articles;

step 23, cleaning the aluminum articles with mildly alkaline solution;

step 24, second water washing treatment for the aluminum articles;

step 25, third water washing treatment for the aluminum articles;

step 26, drying the aluminum articles; and

step 27, removing the aluminum articles from the holder 10.

In step 21, also referring to FIG. 2, the aluminum articles in semi-manufactured state, may be a plate or any other shape piece. Some impurity, such as oil stains or oxides, may attached to an outer surface of the aluminum articles. The holder 10 is made of a plurality of lacunaris plates 12, so that the aluminum articles can be fully immerged in water or cleaning solution during cleaning. The lacunaris plates 12 form a plurality of cavities 14 for respectively receiving the aluminum articles, so as to prevent the aluminum articles from contacting/impacting with each other during cleaning.

In step 22, the holder 10 is set in water. The water used to wash the aluminum articles may be tap water or pure water such as distilled water. In this step, dusts on the outer surfaces of the aluminum articles are mostly removed, and the oil stains and oxides are partly removed.

In step 23, the holder 10 is then set in an ultrasonic cleaning machine. The ultrasonic cleaning machine has four tanks, and at least one tank is filled with mild alkaline solution. The holder 10 is received in one of the tanks of the ultrasonic cleaning machine. The aluminum articles are then soaked/washed in the mild alkaline solution. The mild alkaline solution includes phosphate, carbonate and silicate. The PH value of the mild alkaline is in a range of 8.4˜10 and this mild alkaline solution reacts with the surface oxides without eroding the surfaces of the aluminum articles. It should be understood that the PH value of the mild alkaline solution will increase when the temperature increases. The alkaline solution may erodes the outer surfaces of the aluminum articles when the temperature of the mild alkaline solution is above 60° C. In addition, the mild alkaline solution may not reacts with the surface oxides of the aluminum articles when the temperature of the mild alkaline solution is under 40° C. Therefore, the temperature of the mild alkaline solution is, preferably, between the range of 40° C.˜60° C. The desire temperature of the mild alkaline solution is 55° C. The mild alkaline solution is shaken by ultrasonic emitted from the ultrasonic cleaning machine, so as to remove oxide and oil stains on the surfaces of the aluminum articles.

In step 24, the holder 10 is placed in another ultrasonic cleaning machine filled with water. This step is for removing the mild alkaline solution remains on the surfaces of the aluminum articles. The water used to wash the aluminum articles may, advantageously, be pure water, such as distilled water, so as to increase the cleaning efficiency.

In step 25, the holder 10 is set in an automatic washing machine. The impurity on the outer surfaces of the aluminum articles is gradually removed by the automatic washing machine with a predetermined cleaning procedure stored therein.

In step 26, the aluminum articles is dried by a high pressure blower or by other means. This step is for removing water and any other impurities remain on the surfaces of the aluminum articles.

In step 27, the aluminum articles are removed from the holder 10 and are prepared for surface treatment.

It should be understood that if cleaning only one aluminum article, the holder 10 can be omitted and the aluminum article can be directly received in the water or cleaning solution during cleaning.

It should be understood that the method for cleaning aluminum articles of the present invention omits a step of activation, which simplifies the process of cleaning the aluminum articles. In addition, the method for cleaning aluminum articles of the present invention uses mild alkaline solution instead of strong alkali solution, so that the surfaces of the cleaning aluminum articles can avoid being eroded by strong alkali solution, such as potassium hydroxide solution. Thus, the efficiency of cleaning aluminum articles and the quality of the aluminum articles is increased.

It is to be further understood that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method for cleaning aluminum articles, comprising steps of:
first water washing for an aluminum article;
cleaning the aluminum article with mildly alkaline solution which includes phosphate, carbonate and silicate; and
second water washing for the aluminum article.

2. The method as claimed in claim 1, further comprising a step of third water washing for the aluminum article in an automatic washing machine after the step of second water washing for the aluminum article.

3. The method as claimed in claim 2, further comprising a step of drying the aluminum article after the step of third water washing for the aluminum article.

4. The method as claimed in claim 1, wherein the aluminum article is washed in an ultrasonic cleaning machine in the step of second water washing for the aluminum article.

5. The method as claimed in claim 1, wherein the mildly alkaline solution is received in an ultrasonic cleaning machine.

6. The method as claimed in claim 1, wherein the temperature of the mildly alkaline solution is between 40° C.-60° C.

7. The method as claimed in claim 6, wherein the temperature of the mildly alkaline solution is 55° C.

8. The method as claimed in claim 1, wherein the aluminum article is washed with tap water in the first water washing.

9. The method as claimed in claim 1, wherein the aluminum article is washed with pure water in the step of first water washing for the aluminum article.

10. The method as claimed in claim 1, further comprising a step of fixing the aluminum article on a holder before the step of first water washing for the aluminum article, wherein the number of the aluminum article is plural, and the holder is made of lacunaris plate in which a plurality of cavities are defined for receiving the aluminum articles.

11. The method as claimed in claim 1, wherein the PH value of the mildly alkaline solution is between 8.4˜10.
